(19) United States
(12) Patent Application Publication
(10) Pub. No.: US 2009/0193267 A1
(43) Pub. Date: Jul. 30, 2009

(54) Secure electronic medical record storage on untrusted portal

(76) Inventor: Chiasen Chung, Burnaby (CA)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/021,221

(22) Filed: Jan. 28, 2008

(51) Int. Cl. G06F 12/14; H04L 9/00

(52) U.S. Cl. 713/193; 705/50

(57) ABSTRACT

Patients' medical records are encrypted using a symmetric encryption algorithm and stored on a server that is accessible via a distributed data network. The keys used for encrypting the records are also encrypted, using a public key of a creator of the record, and the encrypted record keys are stored on the server. Facilities for sharing records with other users and for modifying records are also described.

### FIELD

The invention relates to medical record privacy and security. More specifically, the invention relates to methods for securely storing medical records on widely-accessible storage servers, where the servers need not offer any guarantees about the security of the data they store.

### BACKGROUND

There is a growing trend in clinics and hospitals to store patients' medical records electronically. There are generally two approaches to implementing electronic medical record (EMR) systems: localized network and portal-access. The first approach requires the health institutions to manage a network of computers. A storage server is installed and managed by the institution to archive electronic records, so that numerous computers within the network can access the records. Such systems usually have high startup costs, and the clinics will need to employ technical experts to maintain these systems.

Portal-access systems, on the other hand, take the load of system management off the health institution by offering the service of storing their medical records remotely, accessible via the Internet. Each patient (or health practitioner) logs onto the portal to access the medical records. Since these records are available online, they can be readily shared with health practitioners at the discretion of the record owner. However, in the event that Internet connectivity is unavailable, the medical records will not be accessible. Moreover, the patient's privacy is compromised in such systems because the operators of these portals can access the medical records stored there.

The information an EMR system manages can be categorized into three kinds:
1. Patient medical data such as medical histories, laboratory test results and radiology images, etc.
2. Services for practitioners such as billing records and scheduling plans.
3. Contextual references: information or articles that are related to the health of the patient.

A method for storing patient medical data on an Internet-accessible server, as a portal-access EMR system does, without requiring constant Internet connectivity and without compromising patient privacy, may be of value in this field.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 shows an overview of an environment where an embodiment of the invention operates.

FIG. 2 shows an example hierarchical tree of data structures for managing users and groups within the inventive system.

FIG. 3 outlines a method for adding a new medical record according to an embodiment of the invention.

FIG. 4 outlines a method for retrieving and using a method stored according to an embodiment of the invention.

FIG. 5 shows how a first user of the system can share a medical record stored securely within the system with a second user.

FIG. 6 outlines a method for making changes to a record stored within the system.

FIG. 7 illustrates a method for preparing an invoice based on data in a record stored within the system.

FIG. 8 shows some components and subsystems of a computer system that implements an embodiment of the invention.

### DETAILED DESCRIPTION

Embodiments of the invention utilize an Internet portal to act as a storage server for individual users (i.e., health care workers and patients) to keep their medical records, allowing the users to access their records from different computers. These records are kept on the server in encrypted form. Copies of the records are also kept in each user's computer such that when a change has been made, any copies on other computers will also be updated. If a computer is temporarily not connected to the Internet, the change will be cached locally until Internet connection has been established to allow record synchronization with the server.

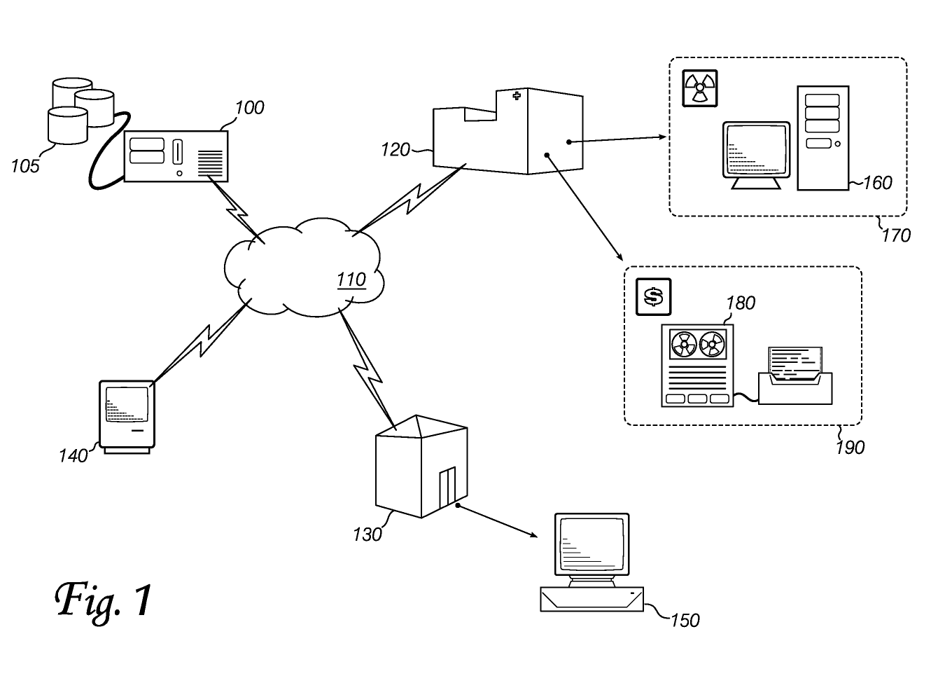

FIG. 1 shows an overview of the environment within which an embodiment of the invention operates. A storage server 100 is accessible via a distributed data network 110 such as the Internet. Storage server 100 provides data storage on mass storage devices 105, which may be operated as a Redundant Array of Independent Disks (“RAID array”). Server 100 hosts the storage of medical records from various health institutions. For example, hospital 120 and clinic 130 may store medical records there. The medical records are stored on the server in encrypted form. The operator of storage server 100 need not have access to any keys to decipher the records.

Since storage server 100 is accessible through distributed network 110, the medical records are available to users of any computer system that can reach the network. For example, a patient's home computer 140, a doctor's computer 150, a computer 160 in the radiology department 170 of hospital 120, or an invoicing system 180 of the hospital's billing department 190 can retrieve the encrypted records. Embodiments of the invention manage encryption keys to control access to the information in the stored records. Some embodiments are client applications that execute at one of the computers shown here to interact with storage server (“portal”) 100.

The encrypted medical records at server 100 can be stored in any format, including the Health Level Seven (“HL7”) standard format, Joint Photographic Experts Group (“JPEG”) compressed images, or Portable Document Format (“PDF”) by Adobe Systems Incorporated of San Jose, Calif. Records in proprietary data formats of medical testing and analysis systems can also be stored. If a proprietary format is used, a browser or editor can be made available on the server for download, so that the record can be viewed by any authorized party, even one lacking the testing system. For example, a Magnetic Resonance Imaging (“MRI”) image may be produced by a specialized machine, but the image may be viewed at any computer by using an appropriate viewer.

Communications between a computer and the storage server over the distributed data network may be carried via Transmission Control Protocol (“TCP”) connections, and may be protected by an end-to-end encryption protocol such as the Secure Sockets Layer (“SSL”).

Although the records downloaded from the storage server are decrypted before they are stored on a client computer, the mass storage device at the client computer that contains these records may be protected by a volume-wide encryption system such as the Encrypting File System (“EFS”) or BitLocker Drive Encryption by Microsoft Corporation of Redmond, Wash. This client-side encryption ensures that, if the client computer is ever stolen, the privacy of the records will not be compromised.

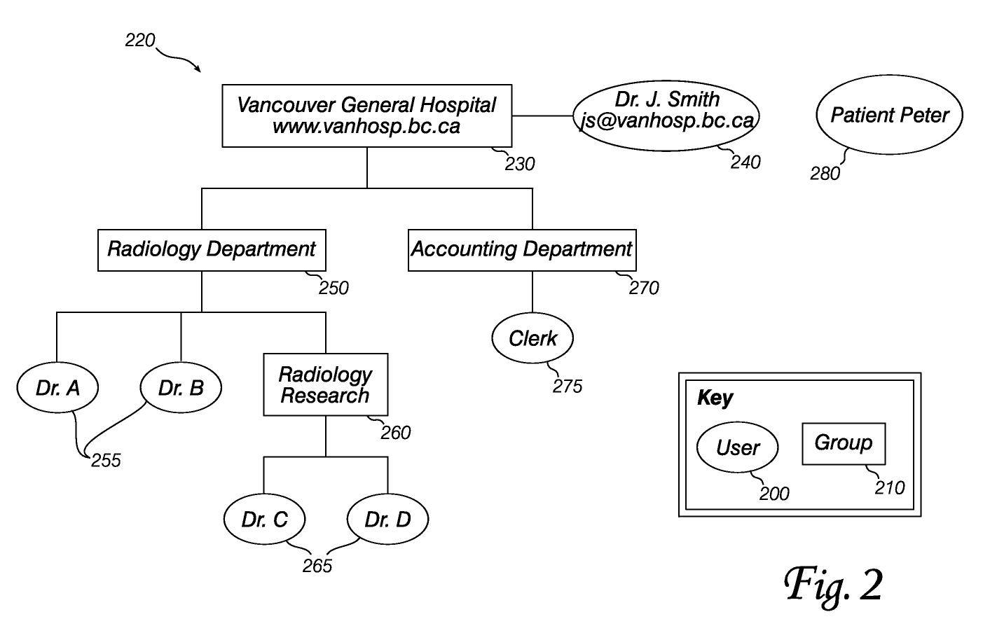

FIG. 2 shows several types of data records that are involved in controlling access to the encrypted medical records stored at storage server 100 in FIG. 1. There are two basic types of records: user records 200 (depicted as ovals) and group records 210 (depicted as rectangles). A user record refers to a person (such as a patient or a doctor), or to a role (such as an accounting clerk or a pharmacist). A group record aggregates one or more user and group records into a common unit. Each record has information such as the name of the person, role or group; an electronic address (e.g., email address or website address); and other information as discussed below. In particular, each record includes a public key of a public/private key pair. Records have a universally-unique identifier such as an ID number so that similarly-named users or groups can be distinguished.

Records are often related in a hierarchy. FIG. 2 shows an example hierarchy 220: a top-level group record 230 represents a hospital. This group record includes information such as a name, an Internet address, and so on. A user record 240 may be associated with the group record to identify a responsible person for the group. In this example, Dr. J. Smith is the chief administrator for the Vancouver General Hospital.

Within hierarchy 220, groups for various hospital departments 250, 270 are shown. Several doctors 255 are members of the Radiology Department 250. The hierarchy may be extended to an arbitrary depth. Here, a Radiology Research group 260 is located in Radiology Department 250, and two doctors 265 are assigned to the research group. In Accounting Department 270, a “clerk” role 275 may be used by any accounting employee who requires access to patient records (e.g. to prepare invoices). Users can also exist outside of a hierarchy. For example, user record 280 describes a patient, who may be the subject of one or more medical records.

A group record may have an associated user record, where the user serves as an “owner” for the group. A group owner ensures that the group's members are consistently up to date. Only the owner can add a user to the group or remove a user from the group.

A patient account may be associated with multiple medical records issued by different practitioners. Every practitioner is associated with exactly one health institution (such as hospital or clinic). (I.e., every user record is a part of at most one hierarchy.) If a practitioner works in two different health institutions, then he/she will have two practitioner accounts, one for each institution. A health institution must be registered with the storage server before its practitioners can store and retrieve medical records. In one embodiment, only health institutions whose Internet domain can be verified through a Certificate Authority (“CA”) service can be registered with the storage server.

To allow medical records to be shared correctly with the right users, an embodiment of the invention maintains a Practitioner Lookup Table so that users can validate the identity of a practitioner. The table consists of multiple health institutions that are made up of hierarchies of groups. Each group is managed by a group owner who holds a practitioner account. The group's members consist of multiple practitioners or sub-groups. Every practitioner in a hierarchy tree belongs to the same institution. A hierarchical structure is used in the lookup table so that an Account-ID can be uniquely verified if an institution has multiple practitioners with the same name.

To illustrate how the Practitioner Lookup Table may be used, suppose Dr. Alice of ABC Hospital wants to obtain the Account-ID of Dr. Bob in XYZ Hospital so that she can share a medical record with him. She will do a search of the Practitioner Lookup Table for the name “Dr. Bob” and “XYZ Hospital.” The system will present a list of practitioner Account-IDs that match the query. Dr. Alice can then walk up each hierarchical tree to verify if a matching “Dr. Bob” in the results is indeed the person she is looking for. When she reaches the root of a hierarchy, she can validate the institution by verifying its certificate.

### Record Access Control

Each patient can have multiple medical records stored at the storage server, and each record is associated with exactly one patient and one owner. A record can only be owned by the patient or any practitioner. In some embodiments, a newly-created record is assigned by default to the practitioner who created the record. Ownership of a record can be transferred by the patient or by the record owner. Practitioners can create multiple medical records for a patient, but in general, a first practitioner cannot access medical records created by a second practitioner unless the second practitioner grants appropriate access rights to do so. In one embodiment, each record has five types of access-right permissions:

TABLE 1

| Name | Meaning |
|---|---|
| Read | User can download the record from the storage server |
| Write | User can upload the record to the storage server |
| Delete | User can delete the record from the storage server |
| Share | User can grant access to the record to another user or group |
| Revoke | User can remove access rights from another user or group |

The owner of a record will always have full access to the record. The owner can always change the owner to someone else (i.e., the owner can give the record to another user). The owner can always re-encrypt the record with a new encryption key.

The patient who is the subject of a record will always have read access to the record, and can always assign ownership of a record to himself or to another user.

A user with sharing rights to a record can assign access rights to a group. Rights of a group are recursively inherited by members of the group. For example, if a group has write-access to a record, then all of the group's members (including any sub-groups and members thereof) will have write-access too.

A user may not grant to another access rights she does not have. For example, if Dr. Alice has read-access and share-access but no write-access to a record, then if she shares the record with Dr. Bob, she cannot assign write-access to Dr. Bob.

### Encryption Key Management

Embodiments of the invention use encryption to control access to the medical records stored at the storage server. There are three types of encryption keys involved in the interactions described below. In some embodiments, all of the encryption keys are created on a client computer (i.e., the storage server is not involved in the selection of encryption keys). The three types of encryption keys are:
User Account Public Key Encryption (“PKE”) Key Pair
Every user account has a public/private key pair. The public and private keys of a key pair are denoted by K_{public} and Kₚᵣᵢᵥₐₜₑ. (The identity of a user may also be included: K_{public Alice} or K_{private-Bob}.)
Group Account PKE Key Pair
Every group also has a public/private key-pair, denoted K_{public}, Kₚᵣᵢᵥₐₜₑ, K_{public-Group}, etc.
Medical Record Key
Every medical record is encrypted using a symmetric encryption algorithm with a unique medical record key, denoted K_{record}. Encryption algorithms suitable for use with an embodiment of the invention include, without limitation, the Data Encryption Standard (“DES”), triple encryption with DES (“3DES”), the Advanced Encryption Standard (“AES”), and the International Data Encryption Algorithm (“IDEA”).

When a public/private key pair for a user is created, the public key (K_{public}) may be stored on the server in its plaintext form. Those of ordinary skill in the relevant arts will understand that this permits others to encrypt data so that only the possessor of the user (or group) private key (Kₚᵣᵢᵥₐₜₑ) can decrypt it, and also to verify that an encrypted object was encrypted with Kₚᵣᵢᵥₐₜₑ (the latter capability can be used as a cryptographic “signature”). As for the private key, it may be stored in a number of different ways. In a first preferred embodiment, Kₚᵣᵢᵥₐₜₑ is encrypted with a user password and then stored on the server. In a second preferred embodiment, Kₚᵣᵢᵥₐₜₑ is stored on a security token such as a Smart Card so that it can be easily carried by the user. Either of these private key storage methods allows the user to access his/her private key on any computer.

When a user is added to a group (or sub-group), he/she is given a copy of the group private key. This copy of the K_{private-Group} is encrypted using the user's public key and may be stored on the server. The user can access resources shared with the group by decrypting K_{private-Group} with his/her own private key Kₚᵣᵢᵥₐₜₑ, and then using the decrypted K_{private-Group} to decrypt the resource.

### Record Access Scenarios

The following figures describe sample access patterns that may occur as a physician, Dr. Alice, creates, modifies, shares and deletes a medical record pertaining to her patient, Peter.

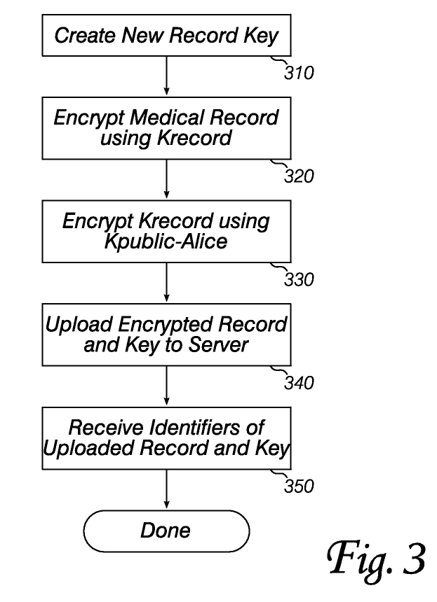

FIG. 3 outlines a procedure by which Dr. Alice can add a new medical record to the storage server. The record may be, for example, data collected by an analysis or monitoring instrument, X-ray images, observations recorded during an examination, audio and/or video of a surgical procedure, a prescription for medicine, or the like. Recall that Dr. Alice has, as part of her enrollment to use the system, created a public/private key pair (K_{public-Alice} and K_{private-Alice}). K_{public-Alice} and K_{private-Alice} are available to Dr. Alice as she performs the procedure described here.

First, a new symmetrical encryption key K_{record} is selected (310). This key is used to encrypt the medical record (320), producing an encrypted data object called a “blob”: B_{record}. In some embodiments, each record encryption key is used for only one medical record. Next, the symmetrical encryption key K_{record} is encrypted using Dr. Alice's public key K_{public-Alice} (330), producing a second encrypted data object: B_{key}.

B_{record} and B_{key} are transmitted to the server for storage (340). Note that neither blob is useful without knowledge of Dr. Alice's private key, K_{private-Alice}, so the security of the storage server is not critical to protecting Peter's privacy. Upon receiving the blobs, the server will generate a record identification number (“Record ID”) and a key identification number (“Key ID”), and return these ID numbers to Dr. Alice (350). Both Dr. Alice and the server will use the ID numbers to refer to the encrypted blobs in the future.

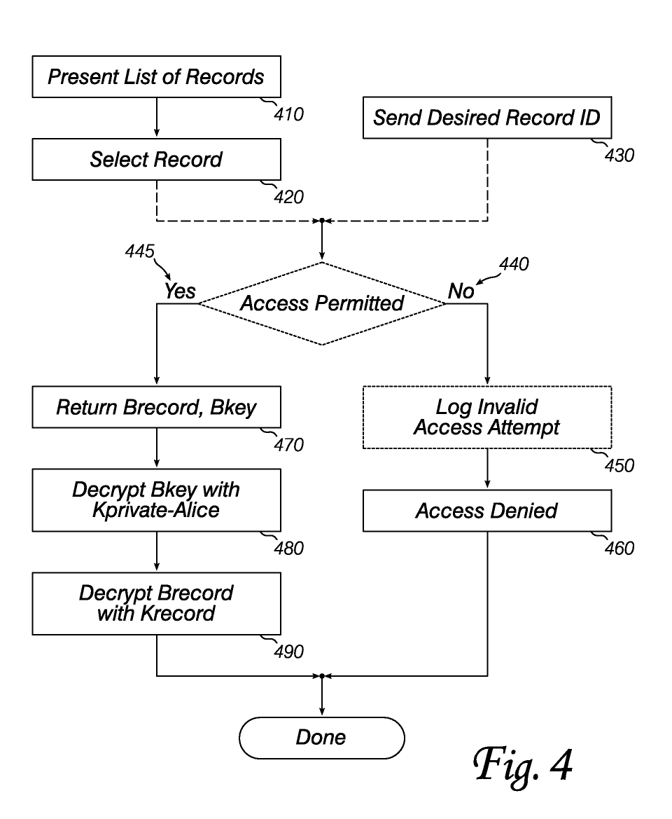

FIG. 4 outlines a method by which Dr. Alice can retrieve a record from the server. This may be an older record of which Dr. Alice no longer has a copy on her local computer, or a recently-created record that is being accessed for the first time at another computer. The server may provide a listing of stored blobs (410) and accept Dr. Alice's selection of one of them (420), or Dr. Alice may send the ID of the record she wishes to obtain (430). In some embodiments, the server may keep access-control information, and if Dr. Alice is not permitted to retrieve the selected record (440), then access is denied (460). (A security log may also be kept to record unauthorized access attempts (450).)

If access is permitted (445) (or access permissions are not checked), then the selected encrypted record (B_{record}) and its corresponding encrypted key (B_{key}) are returned (470). Dr. Alice recovers the record key K_{record} from B_{key} by using her private key K_{private-Alice} (480). Finally, K_{record} is used to decrypt B_{record}, giving the original medical record (490). In a preferred embodiment, if the medical record is to be stored at the client computer, only the encrypted form of the record, B_{record}, is stored.

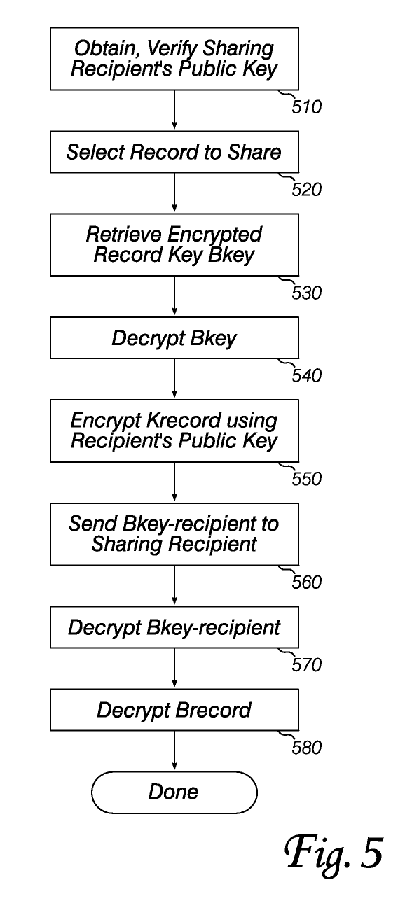

FIG. 5 outlines a sequence of operations by which Dr. Alice can share a medical record of her patient, Peter, with a second physician, Dr. Bob. This may occur, for example, if Dr. Alice wishes to obtain Dr. Bob's advice on the diagnosis or treatment of the patient. Dr. Alice obtains and verifies Dr. Bob's public key, K_{public-Bob}, by referring to the Practitioner Lookup Table as described above (510). By following the listing-and-selection operations 410, 420 of FIG. 4, or by specifying a blob ID directly 420, Dr. Alice locates the (encrypted) record to be shared with Dr. Bob (520). Dr. Alice retrieves the corresponding encrypted record key, B_{key} (530) and decrypts it using her private key K_{private-Alice} (540) to recover the record key, K_{record}. The record key is encrypted with Dr. Bob's public key, K_{public-Bob} (550) to produce a new encrypted record key B_{key-Bob}. The new encrypted record key is transmitted to Dr. Bob (560), who can decrypt it using his private key K_{private-Bob} (570) to recover K_{record}. Dr. Bob can then decrypt B_{record} (580) and review the medical record to assist Dr. Alice.

To share a medical record with all of the members of a group, a user with access to the record can re-encrypt the record key, K_{record}, with the public key of the group, K_{public-group}. Any group member can recover his/her copy of the group's private key using his/her own private key, and then recover the record key using the group's private key.

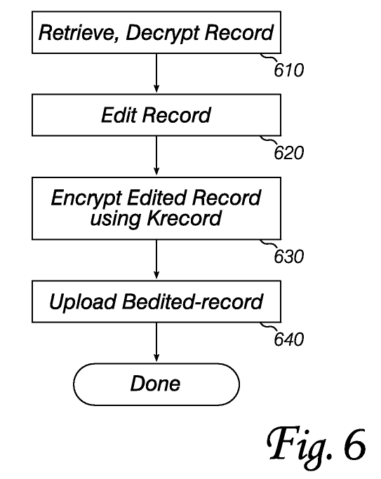

FIG. 6 shows how Dr. Alice can modify a medical record of her patient. First, she retrieves and decrypts the medical record (610), for example by following the method outlined in FIG. 4. Any necessary changes, additions or deletions may be made (620), and the edited record is re-encrypted using the record key K_{record} (630). Finally, the encrypted, edited record B_{edited-record} is uploaded to the server (640) so that the changes will become visible to other users of the record.

### Additional Server Functions

In some embodiments, a storage server can provide additional services to enhance the operation of the inventive medical record storage system, without requiring that the server be trusted to maintain patient privacy. First, in keeping with the optional access control mentioned in connection with FIG. 4 (and particularly elements 440 and 445), the server may provide a more general permissions framework to control the five access rights described at [0028]. For example, Write permission may be required for a modified record to be uploaded to the server, overwriting an earlier version of the record stored there. Similarly, Share permission may be required to execute the record sharing protocol described in reference to FIG. 5.

Second, the server can provide a time reference so that records, keys, access permissions and the like can be granted for a limited period of time. Time-based functionality also facilitates the distribution of record modifications. In an embodiment with this feature, a client periodically checks the server for record changes. If a record has been modified, a new version of the record (encrypted with the original record encryption key, K_{record}) is downloaded. If, during a periodic check, the client is notified that access permissions of a record have changed, any local copies of the record or its key may be discarded. If the user subsequently wishes to access the record, the access control mechanism of FIG. 4 will ensure that granting access is still appropriate.

Third, the server can maintain a journal or log of accesses of each medical record, including a timestamp, an Internet Protocol (“IP”) address of the accessing system, the user or group associated with the access, and the type or purpose of the access. Such a log may show when the record is created, uploaded, downloaded, deleted or shared; and when permissions of the record are altered.

Fourth, the server can maintain a history of changes to a record. In an embodiment with this feature, the server does not overwrite the record when a new (modified) version is uploaded. Instead, earlier versions of the encrypted blob B_{record} are preserved, and a client with read permission on the record can retrieve these versions to determine what changes were made.

Time-reference and record-history functionality can also support a record conflict management feature. Consider a record that is downloaded by two different clients, each of which makes different changes to the record. One client uploads the record to make the changes visible to other users and groups. If the other client attempts to upload its modified copy of the record, the server detects that the “parent” or “source” version of the second modified record was different from the “current” or “latest” version, and disallows the upload. The second client may retry its modifications based on the most recent version of the medical record.

### Key Change and Renewal

In some embodiments, the server will track a lifetime of each encryption key, and enforce a rule that keys whose lifetimes have expired must be renewed. When a user or a group renews its public/private key pair, all record keys encrypted with the old public key must be decrypted and re-encrypted with the new public key. When a record key is first created by the record owner, an expiration date may be specified. The owner can re-encrypt the record with a new key at any time (thus cancelling any prior-granted access, regardless of whether the server supports access revocation), but he/she may be required to do so when the expiration date passes. In some embodiments, only the record owner is allowed to change the medical record key. (In other embodiments, any user or group with Read and Revoke access can change the key.) If the server tracks historical versions of records, then older versions may be left accessible through the old key, or every version of the record may be encrypted with the new key.

The foregoing material outlines capabilities or functionality modules that can be combined to allow medical records to be securely stored on an Internet portal so that records can be readily accessed and shared between patients and health care workers. A system using these modules ensures that the host or operator of the storage portal cannot decipher any of the medical records that it stores, thus assuring that the patients' privacy will not be compromised.

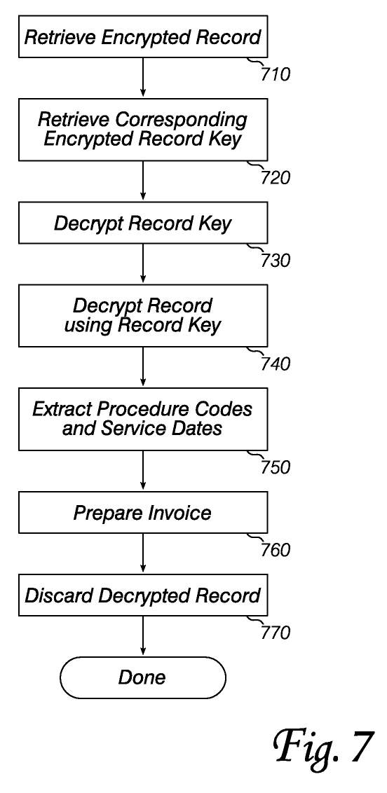

FIG. 7 outlines a complete operational scenario, showing how some of the previously-described encryption, decryption, and key-management features can be combined to accomplish a practical task. The task is the preparation of an invoice or bill based on information stored in a patient's medical record. First, a clerk or a computer program tasked with preparing the invoice retrieves the patient's encrypted medical record from the storage portal (710). Next, the corresponding encryption key for the medical record is retrieved (720). Recall that the encryption key is itself encrypted with a public key belonging to the clerk, the computer program, or to a group to which the clerk or program belongs. The encryption key is decrypted using the corresponding private key (730), and the decrypted key is used to decrypt the medical record (740).

Now, the data in the medical record can be examined, so information such as procedure codes and service dates is extracted (750). Based on this information, an invoice is prepared (760). Finally, the decrypted medical record is discarded (770). The prepared invoice may subsequently be handled through traditional systems. For example, it may be printed and mailed to the patient or transmitted electronically to an insurer. Information such as the total bill amount, due date, credits or discounts, etc., may be entered or transferred into an accounts-receivable system for further processing.

In some embodiments, a patient's medical record may be subdivided into portions, each of which may be encrypted with a different key. This permits closer control of access to the various types of information that may be in the record. For example, a record may contain a date of service and a numeric procedure code (which suffice to prepare an invoice), as well as notes, test results, and impressions entered by the attending physician (which may be of a more private nature, and may not be necessary or relevant for many administrative purposes). Such subdivision of a medical record is logically equivalent to maintaining several individual records, each keyed differently and each containing a portion of the full record, but it may be easier to manage a single record with several sub-portions than to manage several separate partial records.

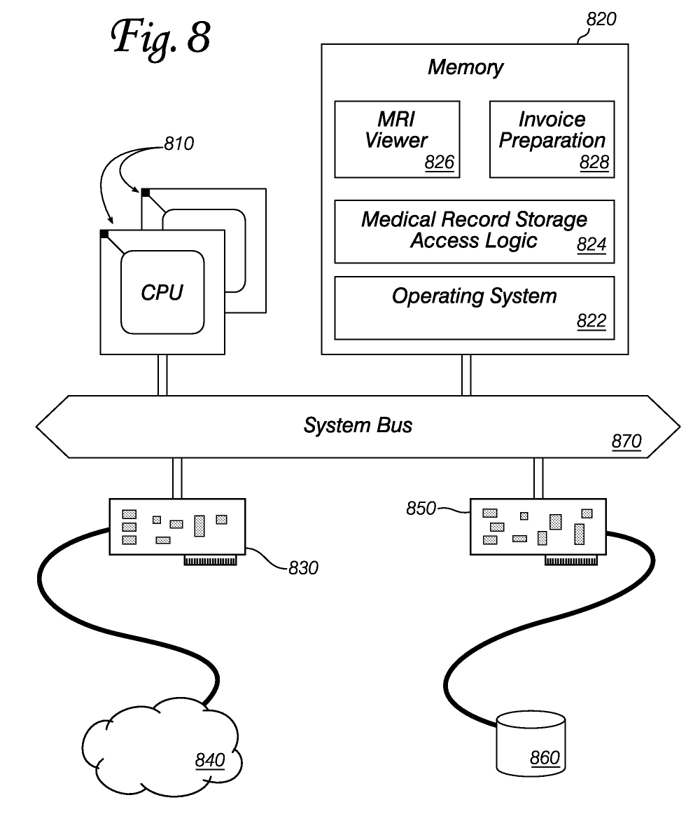

FIG. 8 shows some components and subsystems of a computer system that can participate in an embodiment of the invention. The computer system has one or more programmable processors (two Central Processing Units or “CPUs” 810 are shown in this Figure). CPUs 810 execute instructions stored in a memory 820 to perform methods according to an embodiment. Other instructions may also be stored in memory 820 to cause the CPUs to perform other functions. For example, an operating system (“OS”) 822 is typically provided to manage hardware resources and apportion resources and processing time among various tasks. An embodiment of the invention may be structured as a medical record storage access module 824, presenting to OS 822 an interface similar to an ordinary data storage medium, but performing the previously-described data retrieval, encryption, decryption and key-management tasks as necessary to obtain encrypted medical records and keys from a remote storage repository and decrypt them for use by local applications such as MRI viewer 826 or invoice preparer 828.

A system that implements an embodiment of the invention may include a network interface 830 so that the system can exchange data with other systems via a distributed data network 840 such as the Internet. It may also include a storage adapter 850 so that it can store and retrieve data from a mass storage device 860 such as a hard disk or CD-ROM. These components (and many others not shown) are connected to, and exchange data and control signals by way of, system bus 870.

An embodiment of the invention may be a machine-readable medium having stored thereon data and instructions to cause a programmable processor to perform operations as described above. In other embodiments, the operations might be performed by specific hardware components that contain hardwired logic. Those operations might alternatively be performed by any combination of programmed computer components and custom hardware components.

Instructions for a programmable processor may be stored in a form that is directly executable by the processor (“object” or “executable” form), or the instructions may be stored in a human-readable text form called “source code” that can be automatically processed by a development tool commonly known as a “compiler” to produce executable code. Instructions may also be specified as a difference or “delta” from a predetermined version of a basic source code. The delta (also called a “patch”) can be used to prepare instructions to implement an embodiment of the invention, starting with a commonly-available source code package that does not contain an embodiment.

In the preceding description, numerous details were set forth. It will be apparent, however, to one skilled in the art, that the present invention may be practiced without these specific details. In some instances, well-known structures and devices are shown in block diagram form, rather than in detail, to avoid obscuring the present invention.

Some portions of the detailed descriptions were presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “processing” or “computing” or “calculating” or “determining” or “displaying” or the like, refer to the action and processes of a computer system or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, compact disc read-only memory (“CD-ROM”), and magnetic-optical disks, read-only memories (“ROMs”), random access memories (“RAMs”), eraseable, programmable read-only memories (“EPROMs”), electrically-eraseable read-only memories (“EEPROMs”), Flash memories, magnetic or optical cards, or any type of media suitable for storing electronic instructions.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes a machine readable storage medium (e.g. read only memory (“ROM”), random access memory (“RAM”), magnetic disk storage media, optical storage media, flash memory devices, etc.), a machine readable transmission medium (electrical, optical, acoustical or other form of propagated signals (e.g., carrier waves, infrared signals, digital signals)), etc.

The applications of the present invention have been described largely by reference to specific examples and in terms of particular allocations of functionality to certain hardware and/or software components. However, those of skill in the art will recognize that a secure, privacy-protecting medical record storage and retrieval system can also be implemented by software and hardware that distribute the functions of embodiments of this invention differently than herein described. Such variations and implementations are understood to be captured according to the following claims.

I claim:

1. A method comprising:
encrypting a medical record of a patient with a symmetric encryption key;
storing the encrypted medical record on a storage server;
storing a plurality of copies of the symmetric encryption key on the storage server, each of the plurality of copies encrypted with a public key of a corresponding plurality of public/private keypairs;
retrieving the encrypted medical record and one of the plurality of copies of the symmetric encryption key from the storage server;
decrypting the one of the plurality of copies of the symmetric encryption key with a private key of a public/private keypair; and
decrypting the retrieved, encrypted medical record using the decrypted one of the plurality of copies of the symmetric encryption key.

2. The method of claim 1, further comprising:
encrypting the one of the plurality of copies of the symmetric encryption key with a public key of a record-sharing recipient to produce an encrypted record-sharing key; and
storing the encrypted record-sharing key on the storage server.

3. The method of claim 1, further comprising:
decrypting one of the plurality of copies of the symmetric encryption key with a private key of an authorized party's public/private keypair;
determining whether the authorized party is allowed to share a record encrypted with the symmetric encryption key; and
if the authorized party is allowed to share the record, encrypting the symmetric encryption key with a public key of a record-sharing recipient; and
providing the encrypted symmetric encryption key to the record-sharing recipient.

4. The method of claim 1, further comprising:
deleting one of the plurality of copies of the symmetric encryption key to revoke record access by a corresponding one of the plurality of public/private keypairs.

5. The method of claim 1, further comprising:
modifying the decrypted medical record;
re-encrypting the modified medical record with the symmetric encryption key; and
storing the re-encrypted, modified medical record on the storage server.

6. The method of claim 5, further comprising:
retaining a plurality of historical versions of the medical record, each of the historical versions encrypted by the symmetric encryption key.

7. The method of claim 1, further comprising:
selecting a new symmetric encryption key;
encrypting the retrieved medical record with the new symmetric encryption key to produce a re-keyed medical record;
encrypting the new symmetric encryption key with a public key of a public/private keypair; and
storing the re-keyed medical record and the encrypted new symmetric encryption key on the storage server.

8. A method comprising:
retrieving a record of a patient's medical procedure from a storage server, the record encrypted with a symmetric key K_{record};
retrieving an encrypted key K_{encrypted} from the storage server, the key encrypted with a public key K_{public} of a public/private keypair;
decrypting the encrypted key K_{encrypted} with a private key Kₚᵣᵢᵥₐₜₑ of the public/private keypair to recover the symmetric key K_{record};
decrypting the record with the recovered symmetric key K_{record}; and
preparing an invoice based on a content of the decrypted record.

9. The method of claim 8, further comprising:
deleting the decrypted record after preparing the invoice.

10. The method of claim 8 wherein the record of the patient's medical procedure is one of a scan of a paper document, a data file of a diagnostic apparatus, an X-ray image, a digital photograph, or a document of an office productivity application.

11. The method of claim 8 wherein the record of the patient's medical procedure includes a plurality of sub-sections, each of the sub-sections encrypted with different symmetric encryption keys, and wherein
decrypting the record with the recovered symmetric key K_{record} comprises decrypting fewer than all of the sub-sections.

12. The method of claim 11 wherein a decrypted sub-section contains a date of service and generic service type, but no personal information about the patient.

13. A system comprising:
a storage server for storing a plurality of medical records of a plurality of patients, each of the plurality of medical records encrypted by a corresponding record encryption key;
key management logic to store at least one copy of each record encryption key, each copy of a record encryption key encrypted by a public key of a public/private keypair;
user management logic to track a plurality of users, each user having at least one user public/private keypair;
group management logic to track a plurality of groups, each group having a group public/private keypair; and
an invoicing client having an accounting private key of an accounting public/private keypair, wherein
the invoicing client is to obtain one of the plurality of medical records and a copy of a record encryption key, decrypt the record encryption key with the accounting private key, decrypt the one of the plurality of medical records with the record encryption key, and produce an invoice based on the decrypted one of the plurality of medical records.

14. The system of claim 13, further comprising:
permission logic to control an action by a user, wherein the action is one of reading one of the plurality of medical records, writing one of the plurality of medical records, deleting one of the plurality of medical records, sharing one of the plurality of medical records, or revoking access to one of the plurality of medical records.

15. The system of claim 13, further comprising:
storage access logic to encapsulate encryption and decryption operations on one of the plurality of medical records.

16. The system of claim 13, further comprising:
cleanup logic to delete the decrypted one of the plurality of medical records after producing the invoice.

17. The system of claim 13, further comprising:
practitioner lookup table maintenance logic to store hierarchies of user and group data under a plurality of health institution records.

18. A computer-readable medium storing data and instructions to cause a programmable processor to perform operations comprising:
retrieving an encrypted medical record from a storage server;
caching the encrypted medical record on a local mass storage device;
periodically comparing the cached encrypted medical record to the encrypted medical record at the storage server;
if the encrypted medical record at the storage server is different, replacing the cached encrypted medical record with a new copy of the encrypted medical record from the storage server.

19. The computer-readable medium of claim 18, storing additional data and instructions to cause the programmable processor to perform operations comprising:
during the periodic comparison between the cached encrypted medical record and the encrypted medical record at the storage server, confirming that access permission to the encrypted medical record at the storage server is still available; and
if access permission is not available, deleting the cached encrypted medical record.

20. The computer-readable medium of claim 18, storing additional data and instructions to cause the programmable processor to perform operations comprising:
modifying the cached encrypted medical record; and
transmitting the modified, cached encrypted medical record to the storage server to replace the encrypted medical record at the storage server.

21. The computer-readable medium of claim 18, storing additional data and instructions to cause the programmable processor to perform operations comprising:
modifying the cached encrypted medical record; and
transmitting the modified, cached encrypted medical record to the storage server, wherein
the storage server retains both the encrypted medical record and the modified encrypted medical record.
